(19) United States
(12) Patent Application Publication
(10) Pub. No.: US 2009/0174513 A1
(43) Pub. Date: Jul. 9, 2009

(54) COIL FORMERS FOR MRI MAGNETS

(76) Inventors: David William Ford, Oxfordshire (GB); Jonathan Noys, Oxfordshire (GB)

Correspondence Address: SCHIFF HARDIN, LLP;PATENT DEPARTMENT, 6600 SEARS TOWER, CHICAGO, IL, 60606-6473, US

(21) Appl. No.: 12/347,232

(22) Filed: Dec. 31, 2008

(30) Foreign Application Priority Data
Jan. 4, 2008 (GB) 0800131.5

(51) Int. Cl. H01F 5/02

(52) U.S. Cl. 335/299

(57) ABSTRACT

A former for a coil of a magnet has a coil former body having an axially-extending floor, a first radially extending wall and a second radially extending wall. The walls are positioned at axial extremities of the axially extending floor. A radial dimension of the coil former body at an axial position corresponding to one wall is greater than a radial dimension of the coil former body at an axial position corresponding to the other wall.

### BACKGROUND OF THE INVENTION

1. Field of the Invention

The present invention relates to coil formers used to retain coils which form parts of field magnets for magnetic resonance imaging (MRI) systems.

2. Description of the Prior Art

FIG. 1 schematically illustrates an MRI system employing superconducting coils, according to the prior art. The field magnet 1 is enclosed within a cryostat 2 which cools the field magnet to below the transition temperature of the superconducting coils, and insulates the field magnet from ambient temperature. The cryostat includes a cryogen vessel 3, which surrounds the field magnet 1 and is partially filled with liquid cryogen 4, for example liquid helium. Surrounding the cryogen vessel 3 is an outer vacuum container (OVC) 5. The space between the OVC 5 and the cryogen vessel 3 is evacuated. Placed between the OVC 5 and the cryogen vessel 3 is a thermal radiation shield 6. The thermal radiation shield 6 prevents radiant heat from the OVC reaching the cryogen vessel. The vacuum between the OVC and the cryogen vessel prevents heat being conveyed from the OVC to the cryogen vessel by convection. Mechanical support means, not shown, are provided to hold the field magnet 1, the cryogen vessel 3, the thermal radiation shield 6 and the OVC 5 in the correct relative positions. These mechanical support means have low thermal conductivity, to reduce the heat reaching the cryogen vessel by conduction from the OVC. Refrigeration means (not shown) are typically also provided for cooling the thermal radiation shield 6 and re-cooling the cryogen 4. The field magnet 1 and the cryostat 2 are essentially rotationally symmetrical about axis A-A. References herein to “axial” refer to a direction parallel to axis A-A, while references to “radial” refer to a direction perpendicular to axis A-A.

The present invention, however, is not restricted to such cylindrical magnets, and may be applied to any type of MRI magnets, particularly so-called “open” magnets, which essentially consist of two opposing planar poles, formed by coils.

In addition to field magnet 1, a gradient magnet 7 and RF coils 8 are placed within the bore of the cryostat 2. The gradient magnet serves to produce time-varying magnetic fields in an imaging region 9, and to induce resonance in matter present within the imaging region, and to detect that resonance and so to construct an image of the matter present within the imaging region. Typically, patients' bodies are imaged. Patient 70 is shown lying on a patient bed 72. The patient bed 72, carrying the patient, may be moved into and out of the bore of the cryostat 2. Decorative covers are typically placed over the cryostat 2, the gradient magnet 7 and the RF coils 8, but are not shown in the drawing.

The field magnet 1 includes field coils 10 mounted on an essentially cylindrical main former 11. In addition, shield coils 12 are also provided, of greater diameter than the field coils, and placed outside the former 11 on separate formers 13 provided for the purpose. The shield coil formers 13 are connected to the main former 11 by webs 14 placed at intervals around the circumference of the main former 11. The formers 13 are typically connected to webs 14 by welding.

In operation, electrical current flows through the shield coils 12 in a direction opposite to the prevailing current direction within the field coils 10. An axial force F is exerted upon each of the shield coils, by interaction of their magnetic field with the magnetic field of the main coils.

The present invention particularly relates to the shield coil formers 13, but may be applied to any arrangement in which a coil is mounted within a former and is subject to an axial force.

FIG. 2 shows an enlargement of the region 11 shown in FIG. 1. In particular, it shows a known type of former 13, in radial half-cross-section. In current MRI magnets, the force F may be approximately 155 tonnes (155000 kgf). To strengthen the former 13 to resist this force F, the former 13 may be thickened on its axially outer end. In the illustrated embodiment, the axially outer end of the former 13 is thickened as much as possible, while still leaving a minimum clearance (for example 5 mm) between the former and the cryogen vessel 3.

FIG. 3 shows an enlarged part-cross-sectional view of the former 13 of FIG. 2 when in use. As the force F induced in the coil 12 bears against ha axially outer part of the former 13, the former deforms to a certain extent. The deformation x over a certain height y of the former wall 15 may be expressed as μm/mm. As the former wall 15 deforms, it is clear that the force F is applied to the wall only about a ring 16 near the base of the wall, where the coil is in contact with the wall of the former. The coil 12 itself is typically formed of many turns of wire embedded in epoxy resin. The coil does not itself deform to a significant extent. The concentration of the force F at the ring 16 has been found to cause quenches in a superconducting magnet, as any movement of the coil over the surface of the former wall may cause sufficient heating to induce a quench in the coil.

The former 13 is typically formed by making an extrusion of the profile shown in FIG. 3, then forming the extrusion into a circle by forming it with a desired diameter.

### SUMMARY OF THE INVENTION

An object of the present invention is to further limit the deflection x/y of the wall of the former, to reduce the incidence of quenches.

The above object is achieved in accordance with the present invention by a former for a coil of a magnet, having a coil former body having an axially extending floor, a first radially extending wall, and a second radially extending wall. The walls are respectively positioned at axial extremities of the axially extending floor. The former body has a radial dimension at an axial position corresponding through one wall that is greater than a radial dimension of the former body at an axial position corresponding to the outer wall.

The present invention will be particularly described with reference to magnets composed of superconducting coils, but the invention may also be applied to magnets made up of coils of resistive wire.

The coil formers of the present invention are resistant to deformation due to magnetically induced forces which arise during use of the field magnet. The formers do not require lengthening of the field magnet, nor increase in its outer diameter, as was the case with known formers.

### BRIEF DESCRIPTION OF THE DRAWINGS

FIG. 1 shows an example of a conventional MRI system, to which the present invention may be applied.

FIG. 2 shows an enlargement of a part of FIG. 1.

FIG. 3 shows the deflection of a known coil former in use.

FIGS. 4A-4C show certain embodiments of the coil former of the present invention, in radial half-cross-section.

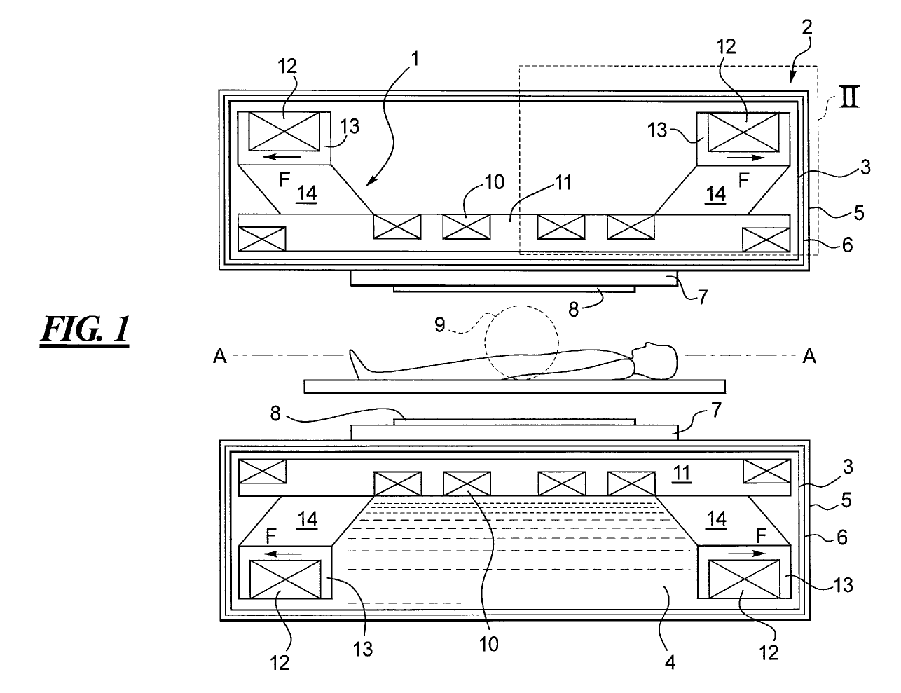

### DESCRIPTION OF THE PREFERRED EMBODIMENTS

According to the present invention, the coil former is provided with a thickened region radially inward of the axially outermost wall 15.

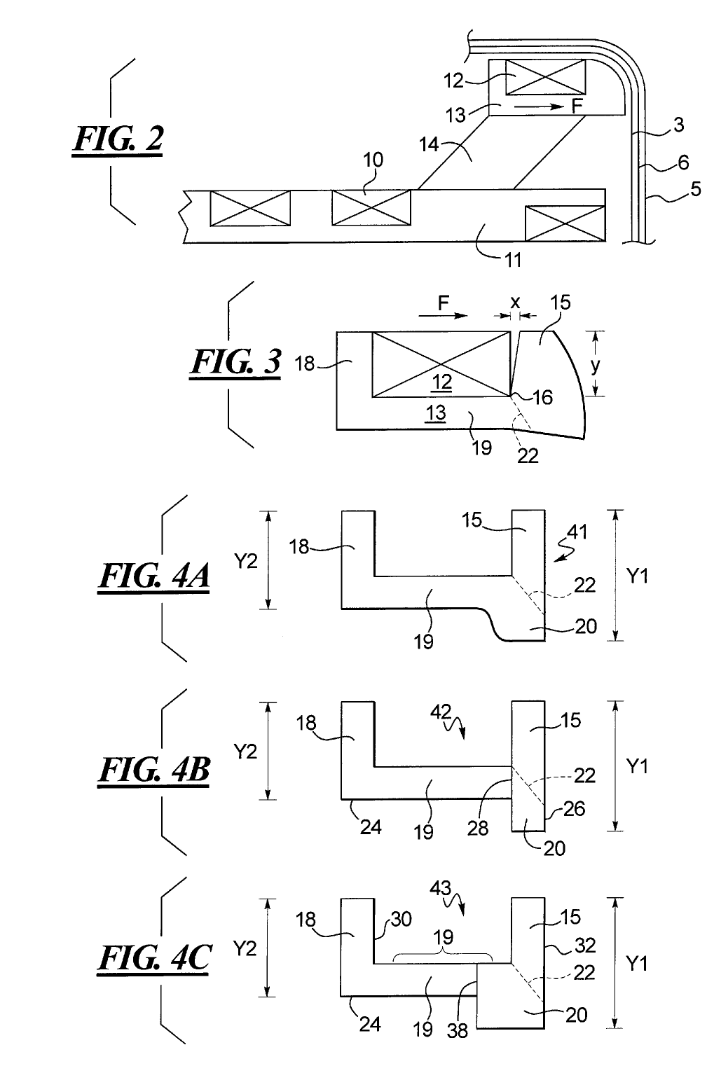

FIG. 4A shows a first embodiment of the present invention. Coil former 41 has axially inner and outer walls 18, 15, respectively. The circular floor 19 of the former is provided with a thickened region 20 radially inward of the axially outermost wall 15. Such a former would be difficult to construct by the conventional method of extrusion and forming into a circle, and the inventors have found that such formers may be satisfactorily formed by casting, using aluminum, glass-fiber-reinforced epoxy resin and other composite materials.

Comparing FIG. 4A with FIG. 3, it is clear that the deformation of the former of FIG. 3 essentially takes place in the region of the join 22 between the floor 19 and the axially outer wall 15. Due to the thickened axially outer wall 15, the deflection essentially takes place by flexing of the floor 19. In the embodiment of FIG. 4A, the whole region of the join 22 between the floor 19 and the axially outer wall 15 is thickened. This arrangement has been found to restrict flexure of the former in this region. As can be seen from consideration of FIG. 3, it is not necessary to thicken the full height of the axially outer end wall 15, as the force F is only applied at ring 16, near the bottom of the wall, near the floor 19.

The resulting reduced deformation due to the action of force F results in reduced tendency to quench.

FIG. 4B shows a radial half-cross-section of a second embodiment of the present invention. In this embodiment, the former 42 is made from an extruded, formed part 24 which provides the floor 19 and the axially inner wall 18, and a planar ring 26, which may be formed by stamping, for example, which provides the axially outer wall 15. The two pieces 24, 26 are joined together at 28, for example by welding. Significantly, the piece 26 extends radially inward of the floor 19, to provide a thickened region 20 radially inward of the axially outermost wall 15. The presence of the thickened region 20 inhibits deformation of the former about the join 22. The resulting reduced deformation due to the action of force F results in reduced tendency to quench.

In a variant of the embodiment of FIG. 4B, the former may be constructed of three separate parts: the ring 26, a second ring forming the axially inner wall 18 and a strip forming the floor 19. The second ring may also be formed by stamping.

FIG. 4C shows a radial half-cross-section of a third embodiment of the present invention. In this embodiment, the former 43 is made from a first extruded, formed part 30 which provides axially inner wall 18 and an axially inner part of the floor 19; and a second extruded, formed part 32 which provides the axially outer wall 15 and an axially outer part of the floor 19. The two pieces 30, 32 are joined together at 38, for example by welding. Significantly, the piece 32 extends radially inward of the floor 19, to provide a thickened region 20 radially inward of the axially outermost wall 15. The thickened region 20 extends axially inward of the axially outer wall to provide a thickened part of the floor 19. The presence of the thickened region 20 inhibits deformation of the former about the join 22. The resulting reduced deformation due to the action of force F results in reduced tendency to quench.

Various other possible constructions will be apparent to those skilled in the art. The invention provides a former for a coil, comprising an axially extending floor 19, an axially inner radially extending wall and an axially outer radially extending wall, wherein a radial height of the former at an axial position corresponding to a wall is greater than a radial height of the former at an axial position corresponding to the other wall. That is, dimension Y1 is greater than dimension Y2, as shown in FIGS. 4A-4C. In certain embodiments, the former is circular. While the above-described embodiments have been explained using the terms “axially inner wall” and “axially outer wall”, the formers of the present invention may be formed with the roles of the walls reversed, for use in cases where the axial direction of the force F acting on a coil to be placed within the former is reversed. The terms “axially inner wall” and “axially outer wall” are accordingly used herein as convenient labels, and are not limiting of the invention.

We claim as our invention:

1. A former for a coil of a magnet, comprising:
a coil former body having an axially-extending floor, a first radially extending wall and a second radially extending wall, said walls being positioned at axial extremities of the axially extending floor, and said former body having a radial dimension at an axial position corresponding to one wall that is greater than a radial dimension of the coil former body at an axial position corresponding to the other wall.

2. A former according to claim 1, wherein said coil former body is comprised of a casting material selected from the group consisting of aluminum, glass-fiber-reinforced epoxy resin, and other composite materials.

3. A former according to claim 1, comprising a joint between said floor and one of said walls, with a region of said joint being thickened.

4. A former according to claim 1, wherein the coil former body is an extruded, formed part comprising the floor and one of said walls, and a planar ring forming the other of said walls.

5. A former according to claim 4, wherein the planar ring extends radially inwardly of the floor (19).

6. A former according to claim 1, wherein the coil former body is constructed of three separate parts comprising a first planar ring, a second planar ring and a strip forming the floor.

7. A former according to claim 1, wherein the coil former body comprises a first extruded, formed part forming one of said walls and part of the floor, and a second extruded, formed part forming the other of said walls and another part of the floor.

8. A former according to claim 7, wherein the second part extends radially inwardly of the floor, to provide a thickened region radially inwardly of the corresponding wall.

9. A former according to claim 1, wherein the coil former body is circular.
